(19) United States
(12) Patent Application Publication
(10) Pub. No.: US 2026/0111544 A1
(43) Pub. Date: Apr. 23, 2026

(54) Non-Transitory Computer-Readable Medium, Method, Apparatus and Computer Program for a Firmware of a Computer System

(71) Applicant: Intel Corporation, Santa Clara, CA (US)

(72) Inventors: Abhishek CHAKRABORTY, Hillsboro, OR (US); Chen LIU, Portland, OR (US)

(21) Appl. No.: 19/422,713

(22) Filed: Dec. 17, 2025

(51) Int. Cl. G06F 21/55

(52) U.S. Cl. CPC G06F 21/554; G06F 2221/034

(57) ABSTRACT

Various examples relate to a non-transitory computer-readable medium, a method, an apparatus and a computer program for a firmware of a computer system to mitigate power telemetry side-channel attacks. The method comprises obtaining a first energy consumption value related to an energy consumption of a processor for a first time window, obtaining a second energy consumption value related to the energy consumption of the processor for a second time window, wherein the second time window has a different length than the first time window, wherein the first and second time window overlap, and generating a modified energy consumption value based on the first energy consumption value and the second energy consumption value to protect against telemetry-based side-channel attacks.

### BACKGROUND

Modern computer systems provide users with software-accessible measurements to monitor hardware resource usage, power efficiency, system performance, and reliability. However, from a security standpoint, any sensitive data-dependent hardware telemetry readings (such as those provided by the Running Average Power Limit (RAPL) interface) can be exploited to extract confidential information (see M. Lipp et al., “PLATYPUS: Software-based power side-channel attacks on x86” in IEEE Symposium on Security and Privacy (S&P), 2021).

Noise injection is a widely used countermeasure deployed by designers to safeguard implementations from various types of side-channel attacks. There are various approaches. For example, hardware-based noise injection schemes such as on-chip noise generators aim to reduce the signal-to-noise ratio (SNR) of the leaked information via side-channel sources may be used (see T. Güneysu and A. Moradi, “Generic side-channel countermeasures for reconfigurable devices” in Cryptographic Hardware and Embedded Systems (CHES) 2021). Hardware modifications are deemed out of scope for products that have already been shipped. Moreover, hardware-based noise injection countermeasures incur silicon overhead, which might be challenging to incorporate in resource-constrained designs. Alternatively, software-based noise injection schemes such as introduction of dummy instructions to cause sufficient power or timing variations may be used to thwart side-channel attacks (see Intel® Software Security Guidance: Frequency Throttling Side Channel Software Guidance for Cryptography Implementations). For software-based schemes, the quality of the noise injection depends on the underlying hardware micro-architecture designs and thus, the same mitigation implementation cannot be ported across different systems due to hardware-level variations. Alternatively, a firmware-based noise injection scheme (see, for example, Intel® security advisory 00389: Running Average Power Limit Energy Reporting) may be used to introduce noise based on energy readings monitored over a single sliding time window to thwart power telemetry side-channel attack. Firmware-based implementation of a single sliding window-based noise injection scheme may not provide an optimal trade-off between security requirement and accuracy of energy telemetry reporting.

### BRIEF DESCRIPTION OF THE FIGURES

Some examples of apparatuses and/or methods will be described in the following by way of example only, and with reference to the accompanying figures, in which:

FIG. 1 shows a block diagram depicting a noise injection-based countermeasure against telemetry side-channel attacks on a Trusted Execution Environment (TEE) workload;

FIG. 2 presents a high-level flow of a single window noise injection technique;

FIG. 3a shows a flowchart of a method for a firmware of a computer system;

FIG. 3b shows a schematic diagram of an apparatus or device for a computer system and of a computer system comprising a (power management) firmware and the apparatus or device;

FIG. 4 shows a flow chart illustrating the proposed double sliding window-based noise injection scheme for mitigating power telemetry side-channel attacks;

FIG. 5 shows a diagram illustrating the advantage of the proposed double sliding window-based noise injection scheme over the single sliding window-based noise injection scheme in terms of accuracy improvement of reported telemetry values; and

FIG. 6 shows a block diagram of an example computer system or computing device.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Various examples of the present disclosure provide a double sliding window-based adaptive noise injection technique to mitigate power telemetry side-channel attacks.

The present disclosure provides an improved methodology to thwart power telemetry side-channel attacks by injecting noise in an adaptive manner based on energy readings over two sliding time windows of different lengths. The proposed technique offers improved accuracy in terms of energy telemetry reporting (and thus, enabling better power and performance (PnP) analysis) over the existing single sliding window-based scheme while maintaining the same security level against side-channel attacks.

The present disclosure provides an improved firmware-based countermeasure to mitigate power telemetry side-channel attacks by considering energy telemetry readings over two sliding time windows to adaptively inject noise. The core concept of the proposed technique is that the trade-off between security requirement and accuracy of energy telemetry reporting can be optimized by injecting noise N into the energy telemetry reporting in a hyperbolic, nonlinear manner to the absolute difference ΔP between power consumption values over the shorter and longer sliding time windows, i.e., N∝(1+αΔP)⁻¹, where α is some configurable scaling factor. This approach may ensure that a low amount of noise is injected when there is already sufficiently high jitter in power consumption patterns arising from background workloads, thus enabling more accurate PnP analysis.

Using the proposed concept, for a given security level requirement in terms of side-channel attack resistance, an improved accuracy in terms of energy telemetry reporting and thus enables better PnP analysis over the single sliding window-based noise injection scheme may be provided. Since the proposed noise injection scheme can be implemented in power management firmware and does not require any hardware modifications, it can also be applied to secure systems which have already been shipped to customers. The proposed technique may enhance the security of TEEs by protecting sensitive data from being extracted by a privileged (ring 0) attacker via Running Average Power Limit (RAPL) interface.

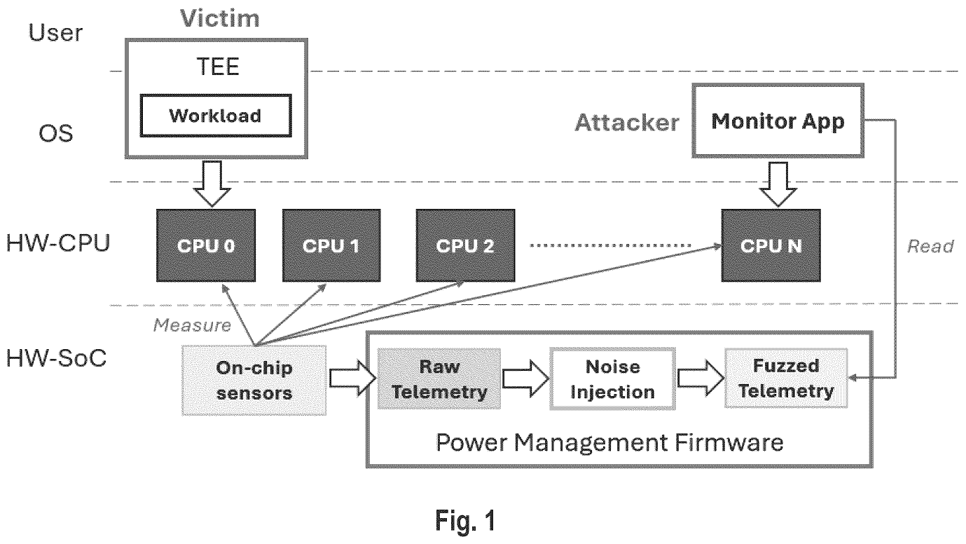

The threat model for a telemetry-based side-channel attack is shown in FIG. 1. FIG. 1 shows a block diagram depicting a noise injection-based countermeasure against telemetry side-channel attacks on a Trusted Execution Environment (TEE) workload. The victim workload is executed inside a TEE which guarantees that even privileged software cannot directly read any secret information from the victim workload. The attacker runs a monitor application (with ring 0 privilege) and reads the telemetry information (e.g., Intel RAPL data) provided by the power management firmware. In M. Lipp et al., “PLATYPUS: Software-based power side-channel attacks on x86” in IEEE Symposium on Security and Privacy (S&P), 2021, it has been demonstrated that such telemetry readings can be analyzed to extract secret data (e.g., AES-NI key) from the victim workload executing inside TEE.

The diagram is organized into four hierarchical layers representing different system levels, namely a User layer, an Operating System (OS) layer, a Hardware-CPU (HW-CPU) layer, and a Hardware-System-on-Chip (HW-SoC) layer. At the User and OS layers, the TEE block is shown on the left side of the diagram, outlined and labeled as “Victim.” The TEE contains a Workload block representing a protected application executing within the secure enclave. On the right side of the OS layer, a Monitor App block is shown, outlined and labeled as “Attacker.” The Monitor App represents a malicious application running with ring 0 privilege that attempts to extract sensitive information by reading telemetry data.

The HW-CPU layer depicts a plurality of processor cores, shown as CPU 0, CPU 1, CPU 2, and CPU N, with a dotted line between CPU 2 and CPU N indicating additional cores in the system. An arrow from the TEE block points to CPU 0, indicating that the victim workload executes on this processor core. The HW-SoC layer contains the Power Management Firmware, which comprises several interconnected blocks. An On-chip Sensors block receives power measurements from the CPU cores, as indicated by arrows labeled “Measure” extending from the HW-CPU layer. The On-chip Sensors block is connected to a Raw Telemetry block, which receives the unfuzzed energy and power measurements. The Raw Telemetry block feeds into a Noise Injection block. The Noise Injection block outputs to a Fuzzed Telemetry block, which contains the perturbed telemetry data after noise has been added. An arrow labeled “Read” extends from the Fuzzed Telemetry block upward to the Monitor App block, indicating that the attacker application accesses the noise-injected telemetry data via the RAPL interface rather than the raw power consumption measurements.

The flow of information through the block diagram proceeds from the victim workload executing within the TEE on CPU 0, through the on-chip sensors that measure power consumption, into the Power Management Firmware where raw telemetry is collected and noise is injected, and finally to the fuzzed telemetry output that is accessible to the software stack.

In order to thwart such telemetry side-channel attacks, a noise injection-based countermeasure is implemented in the power management firmware (see Intel® security advisory 00389: Running Average Power Limit Energy Reporting). As shown in FIG. 1, the noise injection mitigation works by perturbing raw telemetry data read from the on-chip sensors to obtain fuzzed telemetry data which are subsequently exposed to the attacker application. Such a mitigation aims to reduce the signal-to-noise ratio (SNR) of the collected telemetry measurements to hinder extraction of sensitive data from victim applications.

In the following, an overview of the single sliding window-based noise injection scheme currently incorporated in Intel® systems (both client and servers) is given, followed by details on the proposed double sliding window-based noise injection scheme, highlighting its advantages over the other approach.

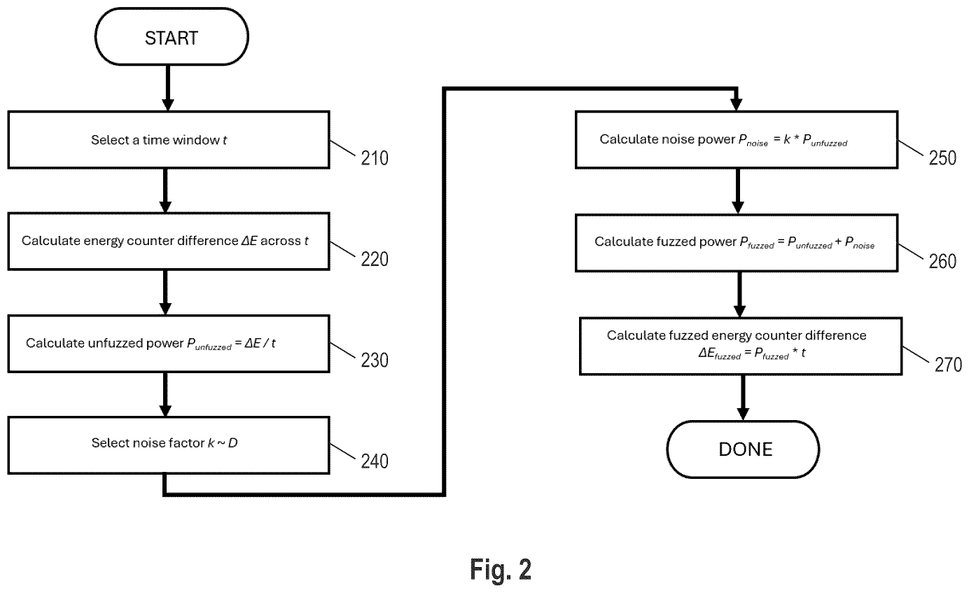

Noise injection schemes implemented in some power management firmware may consider the actual (raw/unfuzzed) energy consumption value over a single sliding time window (of length t) during workload execution and then add noise to it to obtain the fuzzed energy value for reporting purposes to the software stack. FIG. 2 presents a high-level flow of a noise injection technique used in current generation of Intel processors (both client and servers).

FIG. 2 shows a flow chart (including pseudocode) illustrating a single sliding window-based noise injection scheme for mitigating power telemetry side-channel attacks. The flow chart depicts the operations performed by the power management firmware to generate fuzzed telemetry data from raw power measurements.

The flow chart begins with a START block, represented as a rounded rectangle, which initiates the noise injection process. In block 210, a time window t is selected. This time window defines the duration over which energy consumption measurements will be collected for the noise injection calculation. In block 220, the energy counter difference ΔE across the time window t is calculated. This operation involves obtaining the raw energy consumption value measured by the on-chip sensors over the selected time window. In block 230, the unfuzzed power P_{unfuzzed} is calculated by dividing the energy counter difference ΔE by the time window t, expressed as P_{unfuzzed}=ΔE/t. This calculation converts the energy measurement into a power consumption value representing the actual power drawn during workload execution. In block 240, a noise factor k is selected according to a probability distribution D, expressed as k˜D. The probability distribution D is specified by the designer and determines the statistical characteristics of the noise to be injected into the telemetry data.

In block 250, the noise power Pₙₒᵢₛₑ is calculated by multiplying the noise factor k by the unfuzzed power P_{unfuzzed}, expressed as Pₙₒᵢₛₑ=k*P_{unfuzzed}. This operation determines the amount of noise to be added to the telemetry data, where the noise amplitude is directly proportional to the actual power consumption value. In block 260, the fuzzed power P_{fuzzed} is calculated by adding the noise power Pₙₒᵢₛₑ to the unfuzzed power P_{unfuzzed}, expressed as P_{fuzzed}=P_{unfuzzed}+Pₙₒᵢₛₑ. This operation produces the perturbed power value that will be used for telemetry reporting. In block 270, the fuzzed energy counter difference ΔE_{fuzzed} is calculated by multiplying the fuzzed power P_{fuzzed} by the time window t, expressed as ΔE_{fuzzed}=P_{fuzzed}*t. This operation converts the fuzzed power value back into the energy domain for reporting purposes to the software stack. The flowchart concludes with a DONE block, represented as a rounded rectangle, indicating that the noise injection process is complete and the fuzzed energy telemetry data is ready to be exposed to the software stack via the RAPL interface.

In the single-window scheme, the amount of noise injected is directly proportional to the actual (unfuzzed) power consumption P_{unfuzzed} value over the single time window of length t, i.e., Pₙₒᵢₛₑ=k*P_{unfuzzed}. It is noted that the noise factor k is selected according to some probability distribution D as specified by the designer. The equivalent noise injected in energy domain is Pₙₒᵢₛₑ*t. Therefore, the higher the power consumed during workload execution, the larger the amplitudes of noise being added to the telemetry values as reported to the software stack.

The proposed double-sliding window-based noise injection technique is based on the observation that adding noise proportional to the power consumption of workload(s) may not offer an optimal solution to balance the trade-off between security requirement and accuracy of energy telemetry reporting. This is because in this case, the noise injection scheme does not take into consideration the inherent background noise. Even if the background noise is sufficiently high (which corresponds to low SNR, Signal-to-Noise-Ratio), the single-window scheme still unnecessarily injects additional noise, thus impacting the accuracy of PnP analysis.

Various examples of the present disclosure may improve the accuracy of the telemetry reporting framework without compromising the security level of workload(s) against telemetry-based side channel attacks. In order to achieve this objective, the proposed technique requires the power management firmware to consider the actual (unfuzzed) energy consumption values over two sliding time windows (of different lengths tₛₕₒᵣₜ and t_{long}) during workload execution and then utilize that information to inject noise in an adaptive manner to obtain the fuzzed energy values for telemetry reporting purposes to the software stack.

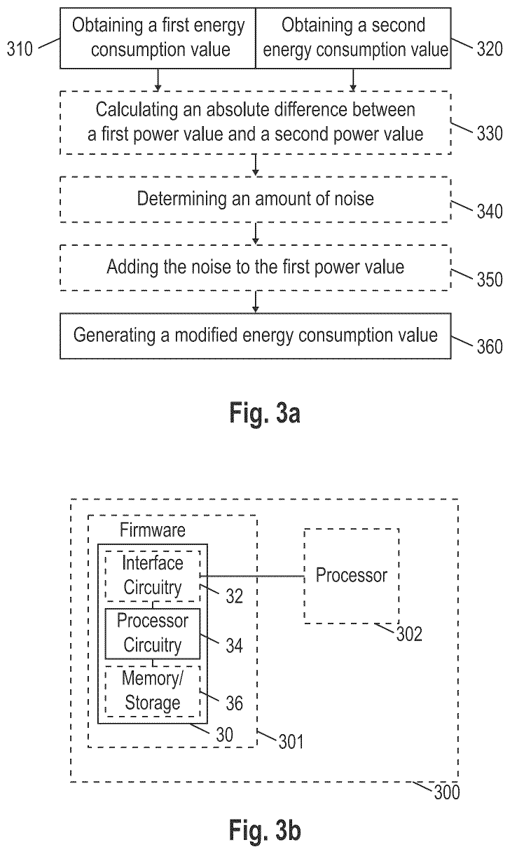

FIG. 3a shows a flowchart of a method for a firmware 301 of a computer system 300 (shown in FIG. 3b). The method comprises obtaining 310 a first energy consumption value related to an energy consumption of a processor 302 (of the computer system 300) for a first time window. The method further comprises obtaining 320 a second energy consumption value related to the energy consumption of the processor for a second time window. The second time window has a different length than the first time window. The first and second time windows overlap. The method comprises generating 360 a modified energy consumption value based on the first energy consumption value and the second energy consumption value. By utilizing overlapping time windows of different lengths, the proposed concept enables the firmware to dynamically adjust the noise added to the energy consumption values, enabling a reduction of the added noise in many scenarios without compromising the security of the computer system. In effect, the modified energy consumption value may be configured to mitigate a power telemetry side-channel attack. By generating modified energy consumption values that obscure the true power consumption patterns, the proposed concept prevents adversaries from extracting sensitive information through power analysis techniques.

FIG. 3b shows a schematic diagram of an apparatus 30 or device 30 for a computer system 300, and of a computer system 300 comprising a (power management) firmware 301 and the apparatus 30 or device 30. The apparatus 30 comprises circuitry to provide the functionality of the apparatus 30. For example, the circuitry of the apparatus 30 may be configured to provide the functionality of the apparatus 30. For example, the apparatus 30 of FIG. 3b comprises (optional) interface circuitry 32, processor circuitry 34, and (optional) memory/storage circuitry 36. For example, the processor circuitry 34 may be coupled with the interface circuitry 32 and/or with the memory/storage circuitry 36. For example, the processor circuitry 34 may provide the functionality of the apparatus in conjunction with the interface circuitry 32 (for communicating with other entities inside or outside the computer system 300, such as a processor 302 of the computer system 300) and the memory/storage circuitry 36 (for storing information, such as machine-readable instructions). Likewise, the device 30 may comprise means for providing the functionality of the device 30. For example, the means may be configured to provide the functionality of the device 30. The components of the device 30 are defined as component means, which may correspond to, or be implemented by, the respective structural components of the apparatus 30. For example, the device 30 of FIG. 3b comprises means for processing 34, which may correspond to or be implemented by the processor circuitry 34, means for communicating 32, which may correspond to or be implemented by the interface circuitry 32, (optional) means for storing information 36, which may correspond to or be implemented by the memory or storage circuitry 36. In general, the functionality of the processor circuitry 34 or means for processing 34 may be implemented by the processor circuitry 34 or means for processing 34 executing machine-readable instructions. Accordingly, any feature ascribed to the processor circuitry 34 or means for processing 34 may be defined by one or more instructions of a plurality of machine-readable instructions. The apparatus 30 or device 30 may comprise the machine-readable instructions, e.g., within the memory or storage circuitry 36 or means for storing information 36. For example, the method of FIG. 3a may be performed by the firmware 301, e.g., by the apparatus 30 or device 30.

For example, the interface circuitry 32 or means for communicating 32 corresponds to one or more inputs and/or outputs designed to receive and/or transmit information. This information can be in digital (bit) values according to a specified code, whether exchanged within a module, between different modules, or even between modules of distinct entities. For example, the interface circuitry 32 or means for communicating 32 may include interface circuitry configured to handle the reception and/or transmission of such information.

For example, the processor circuitry 34 or means for processing 34 can be implemented using one or more processing units, processing devices, or any means for processing, such as a processor, a computer, or a programmable hardware component equipped with appropriately adapted software. Thus, the described function of the processor circuitry 34 or means for processing 34 can be executed in software, running on one or more programmable hardware components. Such components may include a general-purpose processor, a Digital Signal Processor (DSP), a microcontroller, or more. For example, the processor circuitry 34 may correspond to the processor 302. Alternatively, the processor circuitry 34 may be separate from the processor 302.

For example, the memory/storage circuitry 36 or means for storing information 36 may comprise at least one element of the group of a computer-readable storage medium, such as a magnetic or optical storage medium, e.g., a hard disk drive, a flash memory, floppy disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the processor 302 (CPU) may be one of a Central Processing Unit, a Graphics Processing Unit (GPU), a neural/tensor processing unit (NPU/TPU), an artificial intelligence accelerator, or any other type of processor capable of executing machine-readable instructions. For example, the firmware 301 may be a power management firmware of the computer system 300. Alternatively, the firmware 301 may be a system firmware of the computer system 300.

The processor circuitry 34 or means for processing 34 is to perform the method of FIG. 3a. For example, the processor circuitry 34 or means for processing 34 is to obtain the first energy consumption value related to the energy consumption of the processor 302 for a first time window (e.g., via the interface circuitry 32/means for communicating 32). The processor circuitry 34 or means for processing 34 is to obtain the second energy consumption value related to the energy consumption of the processor 302 for the second time window. The processor circuitry 34 or means for processing 34 is to generate the modified energy consumption value based on the first energy consumption value and the second energy consumption value.

In the following, the features of the method of FIG. 3a, a corresponding computer program or non-transitory computer-readable medium storing instructions that, when executed by one or more processing circuitries, cause the one or more processing circuitries to perform the method, the apparatus 30 and the device 30 will be discussed in more detail with reference to the method of FIG. 3a. Features discussed in connection with the method of FIG. 3a may likewise be included in the corresponding computer program, non-transitory computer-readable medium, apparatus 30 and device 30.

Various examples of the present disclosure are based on the finding that power side-channel attacks pose a significant security threat to computer systems. Adversaries can exploit energy consumption measurements of processors to infer sensitive information about the operations being performed. Conventional countermeasures often rely on single-window-based noise injection methods, which may not adequately adapt to varying workload conditions and can either provide insufficient protection or add excessive overhead. The present disclosure relates to a technique for generating modified energy consumption values that provide enhanced protection against power side-channel attacks while adapting the amount of injected noise based on observed power variations.

The proposed concept addresses these challenges by utilizing multiple overlapping time windows of different lengths to analyze energy consumption patterns. By comparing energy consumption values from time windows of different lengths, the firmware can detect power variations that may be exploited by attackers. This improves the security posture of the computer system by enabling adaptive noise injection that responds to the actual power consumption characteristics. The proposed concept results in more effective countermeasures that balance security requirements with system performance, providing stronger protection when power patterns are stable and reducing unnecessary overhead when significant power variations are already present.

In the following, the first time interval is also denoted tₛₕₒᵣₜ and assumed to be shorter than the second time interval, which is also denoted t_{long}. The first energy consumption value is denoted ΔEₛₕₒᵣₜ. It is based on a first difference between an energy measurement at a beginning of the first time window and an energy measurement at an end of the first time window. Accordingly, the second energy consumption value is denoted ΔE_{long}. It is based on a second difference between an energy measurement at a beginning of the second time window and an energy measurement at an end of the second time window. In the following, in addition to the first and second energy consumption value, a first and a second power value is used. The first power value is denoted Pₛₕₒᵣₜ^{unfuzzed} and based on the first difference divided by a first value representing the length of the first time window. The second power value, denoted P_{long}^{unfuzzed}, is based on the second difference divided by a second value representing the length of the second time window. As will be shown in the following, the modified energy consumption value is based on addition of an amount of noise which depends on the first power value and the second power value.

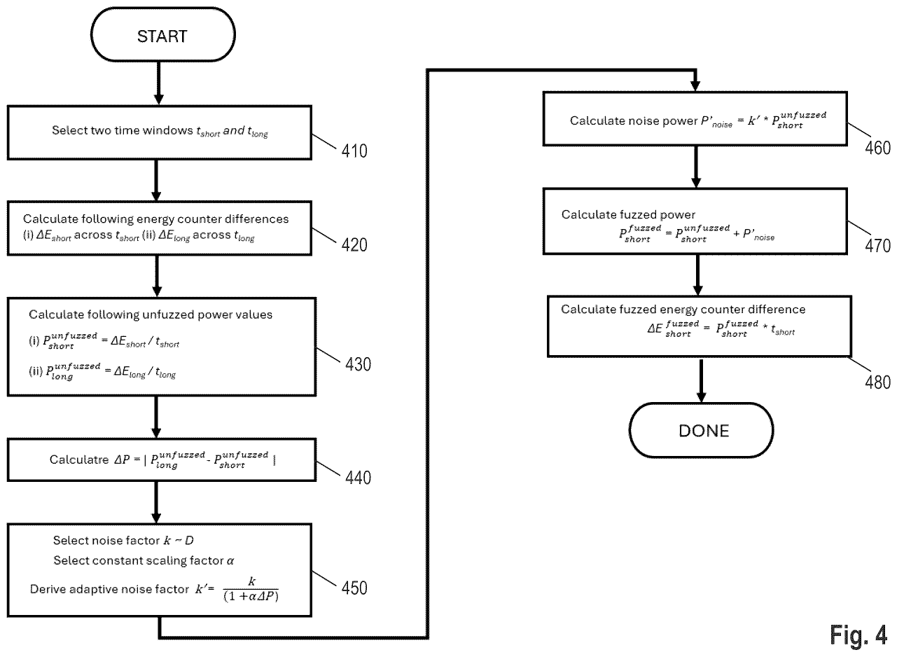

FIG. 4 shows a flow chart (containing pseudocode) illustrating the proposed double sliding window-based noise injection scheme for mitigating power telemetry side-channel attacks. The flow chart depicts the operations performed by the power management firmware to generate fuzzed telemetry data using adaptive noise injection based on energy readings over two sliding time windows of different lengths.

The flow chart begins with a START block, represented as a rounded rectangle, which initiates the adaptive noise injection process. At first, the power management firmware obtains the unfuzzed energy counter differences ΔEₛₕₒᵣₜ and ΔE_{long} (i.e., the first and second energy consumption values) collected across two sliding time windows of lengths tₛₕₒᵣₜ and t_{long} respectively (i.e., the first and second time windows). These values are then converted to corresponding unfuzzed power consumption values

$${P}_{short}^{unfuzzed} and {P}_{long}^{unfuzzed}$$

(i.e., the first and second power values). Next, a parameter called power difference ΔP is calculated by taking the absolute difference between these power consumption values, i.e.,

$$Δ P = \vert {P}_{long}^{unfuzzed} - {P}_{short}^{unfuzzed} \vert .$$

Accordingly, the method of FIG. 3a may comprise calculating 330 the absolute difference ΔP between the first power value

$${P}_{short}^{unfuzzed}$$

associated with the first energy consumption value over the first time window and a second power value

$${P}_{long}^{unfuzzed}$$

associated with the second energy consumption value over the second time window.

In block 410, the two time windows tₛₕₒᵣₜ and t_{long} are selected. These time windows define two different durations over which energy consumption measurements will be collected, where tₛₕₒᵣₜ represents the shorter time window and t_{long} represents the longer time window. In block 420, the (unfuzzed) energy counter differences across both time windows are calculated. Specifically, ΔEₛₕₒᵣₜ is calculated across the short time window tₛₕₒᵣₜ, and ΔE_{long} is calculated across the long time window t_{long}. These values represent the raw energy consumption measured by the on-chip sensors over the respective time windows. In block 430, the unfuzzed power values for both time windows are calculated. The unfuzzed power for the short time window

$${P}_{short}^{unfuzzed}$$

is calculated by dividing the energy counter difference ΔEₛₕₒᵣₜ by the short time window tₛₕₒᵣₜ, expressed as

$${P}_{short}^{unfuzzed} = \frac{Δ {E}_{short}}{{t}_{short}} .$$

Similarly, the unfuzzed power for the long time window P_{long}^{unfuzzed} is calculated by dividing the energy counter difference ΔE_{long} by the long time window t_{long}, expressed as

$${P}_{long}^{unfuzzed} = \frac{Δ {E}_{long}}{{t}_{long}} ,$$

In block 440, the power difference ΔP is calculated by taking the absolute difference between the unfuzzed power values of the long and short time windows, expressed as

$$Δ P = \vert {P}_{long}^{unfuzzed} - {P}_{short}^{unfuzzed} \vert .$$

The power difference parameter represents the variation in power consumption patterns between the two time windows and serves as an indicator of the inherent background noise in the system.

The power difference parameter ΔP is then used to determine the amount of noise to be added. Accordingly, the method may further comprise determining 340 an amount of noise based on the calculated absolute difference, and generating 360 the modified energy consumption value by applying the determined amount of noise to an energy consumption value. By basing the noise amount on the absolute difference between power values from different time windows, the proposed concept provides a mechanism for detecting workload variations and adjusting the countermeasure accordingly.

In various examples, the parameter ΔP (i.e., the absolute difference) is used to derive a new adaptive noise factor k′ as follows:

$${k}^{′} = \frac{k}{( 1 + αΔ P )}$$

where (i) k is the same as the noise factor used in the single window-based scheme (see FIG. 2) and (ii) α is a constant scaling factor which can be adjusted in the power management firmware to scale the value of ΔP as needed. In this calculation, k can be seen as a base noise factor, and k′ is a scaled noise factor. Accordingly, to enable precise control over the adaptive noise behavior, determining 340 the amount of noise may comprise providing a base noise factor (k). This base noise factor may be a noise factor for a single-window-based noise injection method. This allows the proposed concept to leverage established noise parameters while providing the enhanced adaptive functionality. The method of FIG. 3a may further comprise calculating an adaptive noise factor k′ by scaling the base noise factor k based on the calculated absolute difference ΔP. The adaptive noise factor is hyperbolically nonlinearly related to the calculated absolute difference. By deriving the adaptive noise factor from a base noise factor, the proposed concept maintains compatibility with established noise injection parameters while providing the adaptive behavior. As shown above, the adaptive noise factor may be calculated by dividing the base noise factor k by a term that increases with the calculated absolute difference ΔP. This mathematical formulation ensures that as the absolute difference increases, the adaptive noise factor decreases proportionally, resulting in less noise being injected when significant power variations are already present. For example, to allow fine-tuning of the adaptive behavior, the term may be one plus the product of the calculated absolute difference ΔP and a configurable scaling factor α. The configurable scaling factor enables system administrators or firmware designers to adjust the sensitivity of the noise adaptation to match specific security requirements and system characteristics.

In FIG. 4, this is shown in block 450. In block 450, the adaptive noise factor k′ is derived. First, a noise factor k is selected according to a probability distribution D, expressed as k˜D. Then, a constant scaling factor α is selected, which can be adjusted in the power management firmware to scale the value of ΔP as needed. Finally, the adaptive noise factor k′ is derived by dividing the noise factor k by the quantity (1+αΔP). This formulation ensures that the adaptive noise factor k′ is related in a hyperbolic, nonlinear manner to the power difference ΔP, resulting in lower noise injection when there is already high variation in power consumption patterns. In other words, to provide a graduated response to varying power differences, the method of FIG. 3a may comprise determining 340 the amount of noise to be hyperbolic, nonlinearly related to the calculated absolute difference. This nonlinear relationship ensures that the noise injection responds appropriately across a wide range of power variation magnitudes, providing strong protection when power patterns are stable while reducing overhead when significant variations are already present due to background workloads.

The amount of noise injected is directly proportional to the actual (unfuzzed) power consumption P_{unfuzzed} value over the time window of length

$${t}_{short} , i . e . , {P}_{noise}^{′} = {k}^{′} \cdot {P}_{short}^{unfuzzed} .$$

However, unlike the single window-based scheme, in case of the proposed double window-based scheme, high power consumption values due to workload execution over the time window tₛₕₒᵣₜ do not necessarily imply large values of P′ₙₒᵢₛₑ. This is because when there is a high variation in power consumption patterns between the time windows t_{long} and tₛₕₒᵣₜ, it leads to a high ΔP value (or equivalently a low k′ value). This in turn implies that even high values of

$${P}_{short}^{unfuzzed}$$

may result in small amplitudes of added noise to the telemetry data reported to the software stack due to low k′ values. Note that the equivalent noise injected in energy domain is P′ₙₒᵢₛₑ·tₛₕₒᵣₜ.

In FIG. 4, this is shown in block 460. In block 460, the noise power

$${P}_{noise}^{′}$$

is calculated by multiplying the adaptive noise factor k′ by the unfuzzed power of the short time window

$${P}_{short}^{unfuzzed} , expressed as {P}_{noise}^{′} = {k}^{′} \cdot {P}_{short}^{unfuzzed} .$$

This operation determines the amount of noise to be added to the telemetry data in an adaptive manner based on the power difference between the two time windows. In block 470, the fuzzed power

$${P}_{short}^{fuzzed}$$

is calculated by adding the noise power P′ₙₒᵢₛₑ to the unfuzzed power of the short time window

$${P}_{short}^{unfuzzed} , expressed as {P}_{short}^{fuzzed} = {P}_{short}^{unfuzzed} + {P}_{noise}^{′} .$$

This operation produces the modified (perturbed) power value that will be used for telemetry reporting. Accordingly, the method of FIG. 3a may comprise adding 350 the noise to the first power value. By applying noise to the power value derived from the first time window, the modified energy consumption value reflects the adjusted power measurement. In block 480, the fuzzed energy counter difference

$$Δ {E}_{short}^{fuzzed}$$

(e.g., the modified energy consumption value) is calculated by multiplying the fuzzed power

$${P}_{short}^{fuzzed}$$

by the short time window

$${t}_{short} , expressed as Δ {E}_{short}^{fuzzed} = {P}_{short}^{fuzzed} \cdot {t}_{short} .$$

This operation converts the fuzzed power value back into the energy domain for reporting purposes to the software stack. In effect, the method of FIG. 3a may comprise determining 340 the amount of noise to be added to the first energy consumption value. The flow chart concludes with a DONE block, represented as a rounded rectangle, indicating that the adaptive noise injection process is complete and the fuzzed energy telemetry data is ready to be exposed to the software stack via the RAPL interface.

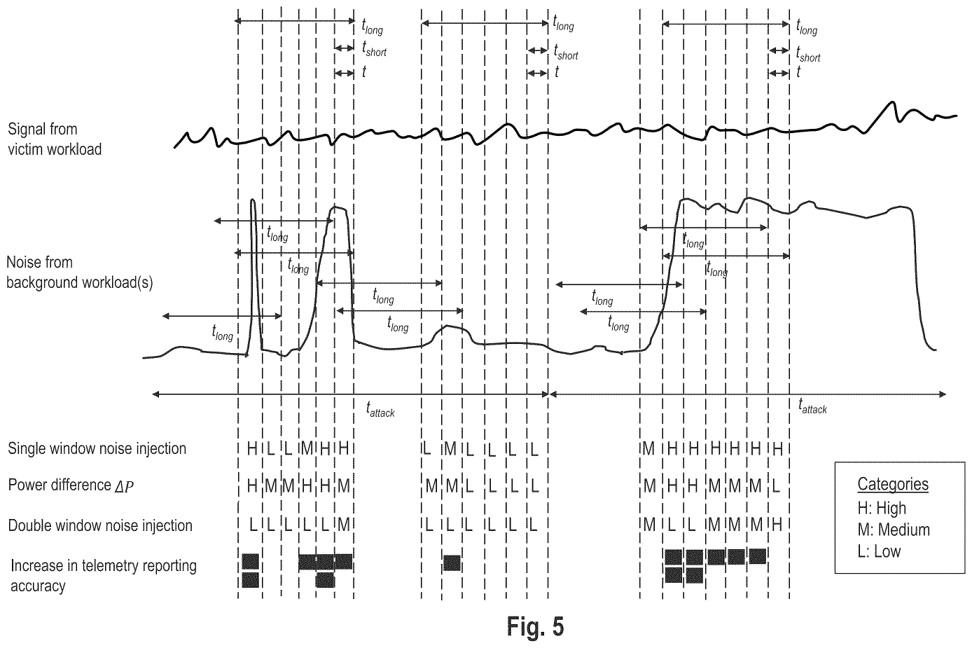

The proposed double window-based scheme injects noise in an adaptive manner to optimize the trade-off between security requirement (resistance to telemetry side-channel attack) and telemetry utility requirement (accurate energy telemetry reporting). This is explained with the help of the illustration in FIG. 5. Depending on the power consumption patterns over sliding time windows tₛₕₒᵣₜ and t_{long} during parallel execution of multiple workloads (victim and background), ΔP value can belong to one of the three categories—low (L), medium (M), and high (H).

When ΔP belongs to category L, the scaling factor k′ value may be large leading to high amount of noise injection. In general terms, when the calculated absolute difference is below a first threshold (and thus determined to be in category “L”), the amount of noise may be determined to be above a second threshold. This ensures that when power patterns are relatively constant and thus more susceptible to side-channel analysis, a minimum level of noise protection is maintained. It is noted that when ΔP=0, k′ attains its maximum value k′=k, where k is the scaling factor used in the single sliding window-based scheme (see FIG. 2). In other words, if the first threshold is substantially zero (e.g., below 1% of a maximal value for ΔP), the amount of noise may be determined to be a maximum amount of noise. This configuration provides the strongest countermeasure when the power consumption is most stable and predictable. As a result, in this case, the maximum amount of noise may correspond to an amount of noise generated by the single-window-based noise injection method. Therefore, the amplitude of noise added to the reported telemetry by the double sliding window-based scheme at most equals that added by the single sliding window-based scheme (worst case scenario). In this case, there is sufficient resistance to telemetry side-channel attack but low accuracy of telemetry reporting.

When ΔP belongs to category H, the scaling factor k′ value is small leading to a low amount of noise injection. When ΔP tends to a very high value, k′ tends to its minimum value k′=0 which corresponds to no noise being added (best case scenario). In this case, (i) there is sufficient resistance to telemetry side-channel attacks targeting victim workloads due to the presence of high noise arising from parallel execution of background workloads as well as (ii) high accuracy of telemetry reporting due to no added noise.

When ΔP belongs to category M, the corresponding scaling factor k′ value leads to a moderate amount of noise injection (average case scenario). In this case, (i) there is sufficient resistance to telemetry side-channel attacks targeting victim workloads due to combination of medium amount of noise injection and moderate amount of background noise and (ii) moderate loss of accuracy in telemetry reporting due to medium amount of added noise.

It is noted that when ΔP value belongs to either of the categories H or M, the proposed double sliding window-based approach offers advantages due to an improvement of the trade-off between security requirement and telemetry utility requirement by injecting low to moderate amounts of noise into the reported telemetry data to the software stack. FIG. 5 highlights the advantage of double window-based scheme (with window lengths tₛₕₒᵣₜ and t_{long}) over single window-based noise injection scheme (with window length t) in terms of accuracy improvement of reported telemetry values under different scenarios of energy consumption profiles during parallel execution of two types of workloads (victim and background).

FIG. 5 shows a diagram illustrating the advantage of the proposed double sliding window-based noise injection scheme over the single sliding window-based noise injection scheme in terms of accuracy improvement of reported telemetry values. The diagram depicts different scenarios of energy consumption profiles during parallel execution of two types of workloads, namely a victim workload and background workload(s).

The upper portion of the diagram displays two waveforms representing power consumption over time. A first waveform labeled “Signal from victim workload” represents the energy consumption pattern of the victim workload executing within the Trusted Execution Environment. This waveform exhibits relatively consistent oscillations with moderate amplitude variations throughout the depicted time period. A second waveform labeled “Noise from background workload(s)” represents the energy consumption pattern of background workloads executing in parallel with the victim workload. This waveform exhibits distinct characteristics including periods of low activity, sharp spikes representing sudden increases in energy consumption, and sustained elevated energy consumption periods followed by gradual decreases.

The diagram indicates three different time window parameters used in the analysis. The time window t represents the single window length used in the existing single sliding window-based scheme. The time window tₛₕₒᵣₜ represents the shorter time window used in the proposed double sliding window-based scheme, where tₛₕₒᵣₜ equals t in this example. The time window t_{long} represents the longer time window used in the proposed double sliding window-based scheme. Additionally, the diagram shows t_{attack}, which represents the time window used by an attacker to measure aggregate energy telemetry values, where t_{attack} is greater than t_{long} and significantly greater than tₛₕₒᵣₜ.

The lower portion of the diagram presents a comparative analysis organized into several rows aligned with vertical dashed lines that divide the time axis into discrete intervals corresponding to the short time window tₛₕₒᵣₜ. A first row labeled “Single window noise injection” indicates the amount of noise injected by the single sliding window-based scheme for each time interval, with values categorized as High (H), Medium (M), or Low (L). A second row labeled “Power difference ΔP” indicates the calculated absolute power difference between the unfuzzed power values over the short and long time windows for each interval, also categorized as High (H), Medium (M), or Low (L). A third row labeled “Double window noise injection” indicates the amount of noise injected by the proposed double sliding window-based scheme for each time interval, categorized as High (H), Medium (M), or Low (L). A fourth row labeled “Increase in telemetry reporting accuracy” displays squares indicating the level of accuracy improvement achieved by the proposed double sliding window-based scheme compared to the single sliding window-based scheme. When the power difference ΔP belongs to the High category, the double window-based scheme injects Low amounts of noise, resulting in one or two squares indicating significant accuracy improvement. When the power difference ΔP belongs to the Medium category, the double window-based scheme injects low or medium amounts of noise, resulting in one or no squares indicating moderate accuracy improvement. When the power difference ΔP belongs to the Low category, the double window-based scheme injects noise at similar levels to the single window-based scheme, resulting in no squares as there is negligible accuracy improvement in this scenario. The diagram demonstrates that when background workloads generate significant power consumption variations, as indicated by high ΔP values, the proposed double sliding window-based scheme advantageously reduces the amount of injected noise while maintaining sufficient protection against telemetry-based side-channel attacks, thereby improving the accuracy of telemetry reporting for energy and performance analysis purposes.

For simplicity, in the example of FIG. 5, tₛₕₒᵣₜ=t but tₛₕₒᵣₜ can be adjusted to any other desired value in the power management firmware as needed. In order to mount a telemetry side-channel attack, the attacker considers a time window of length t_{attack} (where t_{attack}>t_{long} and t_{attack}>>tₛₕₒᵣₜ) to measure the aggregate energy telemetry values (which consists of energy consumption due to execution of all the active workloads). From the perspective of the attacker, the fraction of total energy consumed by the victim workload is considered as the signal whereas the fraction of total energy consumed by the background workload(s) is considered as the noise over the time window t_{attack}. When ΔP value belongs to either of the categories H or M, the proposed double window-based scheme utilizes the noise from background workloads to defend against telemetry side-channel attack targeting the victim workload and simultaneously improves the accuracy of telemetry values reported to the software stack by injecting lesser amount of noise compared to the single window-based scheme. The squares at the bottom of FIG. 5 signify the level of increase in telemetry reporting accuracy depending on the energy profile patterns over tₛₕₒᵣₜ and t_{long} windows—(i) When ΔP is in category H, there are either two or one level(s) of accuracy increase as signified by two or one square(s) respectively in tₛₕₒᵣₜ window (ii) When ΔP is in category M, there are either one or no level of accuracy increase as signified by one or absence of square respectively in tₛₕₒᵣₜ window (iii) When ΔP is in category L, there is negligible accuracy increase as the double window-based scheme injects noise which is in similar scale as that injected by the single window-based scheme to provide sufficient protection against telemetry-based side-channel attacks.

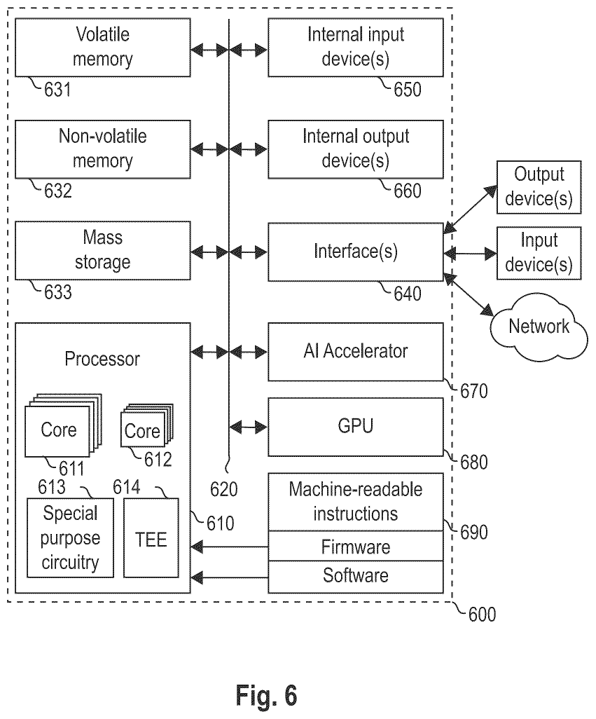

More details and aspects of the double sliding window-based adaptive noise injection technique are mentioned in connection with the proposed concept or one or more examples described above or below (e.g., FIG. 6). The double sliding window-based adaptive noise injection technique may comprise one or more additional optional features corresponding to one or more aspects of the proposed concept or one or more examples described above or below.

FIG. 6 shows a block diagram of an example computer system 600 or computing device 600 structured to execute and/or instantiate the machine-readable instructions and/or operations of FIGS. 1 to 6 to implement the method, apparatus and device for the computer system 600 and/or the computer system comprising or executing the method, apparatus or device of FIGS. 3a to 3b. The computer system 600 or computing device 600 may be, for example, a server, a personal computer, a workstation, a self-learning machine (e.g., a neural network), a mobile device (e.g., a cell phone, a smartphone, a tablet such as an iPad™), a personal digital assistant (PDA), an Internet appliance, a DVD player, a CD player, a digital video recorder, a Blu-ray player, a gaming console, a personal video recorder, a set-top box, a headset (e.g., an augmented reality (AR) headset, a virtual reality (VR) headset, etc.) or other wearable device, or any other type of computing device.

The computer system 600 or computing device 600 of the illustrated example includes processor circuitry 610. The processor circuitry 610 of the illustrated example is hardware. For example, the processor circuitry 610 can be implemented by one or more integrated circuits, logic circuits, FPGAs (Field-Programmable Gate Array), microprocessors, CPUs (Central Processing Units), GPUs (Graphics Processing Units), DSPs (Digital Signal Processors), and/or microcontrollers from any desired family or manufacturer. The processor circuitry 610 may be implemented by one or more semiconductor-based (e.g., silicon-based) devices. For example, the processor circuitry 610 may provide the functionality of the computer system 600 or computing device 600.

The processor circuitry 610 comprises one or more processor cores 611, 612. For example, the processor circuitry 610 may have heterogeneous cores. Heterogeneous cores in CPUs refer to the use of different types of cores within a single processor, typically combining high-performance (BIG) cores with power-efficient (LITTLE) cores. Thus, the processor circuitry 610 may comprise one or more BIG cores 611 and one or more LITTLE cores 612. BIG cores are designed for performance-intensive tasks and provide higher processing power, but they consume more energy. LITTLE cores, on the other hand, are optimized for energy efficiency and handle less demanding tasks to prolong battery life and reduce power consumption.

The processor circuitry 610 of the illustrated example is in communication, e.g., via one or more bus interfaces 620, with a main memory including a volatile memory 631 and a non-volatile memory 632. The volatile memory 631 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 632 may be implemented by flash memory and/or any other desired type of memory device. Access to the main memory 631, 632 of the illustrated example is controlled by a memory controller, which may be implemented by special-purpose circuitry 613 of the processor circuitry 610.

The computer system 600 or computing device 600 of the illustrated example also includes one or more mass storage devices 633 to store software and/or data. Examples of such mass storage devices 633 include magnetic storage devices, optical storage devices, floppy disk drives, HDDs, CDs, Blu-ray disk drives, redundant array of independent disks (RAID) systems, solid state storage devices such as flash memory devices, and DVD drives.

The computer system 600 or computing device 600 of the illustrated example also includes interface circuitry 640. The interface circuitry 640 may be implemented by hardware in accordance with any type of interface standard, such as an Ethernet interface, a WiFi interface, a cellular modem, a universal serial bus (USB) interface, a Bluetooth® interface, a near field communication (NFC) interface, a PCI (Peripheral Component Interconnect) interface, and/or a PCIe (Peripheral Component Interconnect Express) interface. For example, the interface circuitry 640 of the illustrated example may include a communication device such as a transmitter, a receiver, a transceiver, a modem, a residential gateway, a wireless access point, and/or a network interface to facilitate exchange of data with external machines (e.g., computing devices of any kind) by a network. The communication can be by, for example, an Ethernet connection, a digital subscriber line (DSL) connection, a telephone line connection, a coaxial cable system, a satellite system, a line-of-site wireless system, a cellular telephone system, an optical connection, etc.

In the illustrated example, one or more internal input devices 650 and/or one or more external input devices are connected to the interface circuitry 640 or the bus 620. The input device(s) permit a user to enter data and/or commands into the processor circuitry 610. The input device(s) can be implemented by, for example, an audio sensor, a microphone, a camera (still or video), a keyboard, a button, a mouse, a touchscreen, a trackpad, a trackball, an isopoint device, and/or a voice recognition system.

One or more internal output devices 660 and/or one or more external output devices are also connected to the interface circuitry 640 of the illustrated example. The output devices 660 can be implemented, for example, by display devices (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, a printer, and/or speaker. The computer system 600 or computing device 600 of the illustrated example, thus, typically includes a graphics driver card, a graphics driver chip, and/or graphics processor circuitry such as a GPU 613, 680, which may correspond to or be part of the processor circuitry 610, for example as special purpose circuitry 613 or as cores 611, 612, or separate from the processor 610, for example as a separate GPU 680.

The computer system 600 or computing device 600 of the illustrated example may include an AI Accelerator 670. For example, the AI Accelerator 670 may be configured to improve the computational speed and efficiency of machine learning tasks by executing parallel processing operations tailored for neural network models. The AI Accelerator 670 may include hardware such as Graphics Processing Units (GPUs), Tensor Processing Units (TPUs), or other specialized processors designed to handle large volumes of data with low latency. For example, the Processor 610, the AI Accelerator 670, the integrated GPU 613, and/or the dedicated GPU 680 may be considered xPUs (x Processing Units, where x is a placeholder) of the computer system 700 or computing device 700.

The computer system 600 or computing device 600 of the illustrated example includes machine-readable instructions 690. For example, the machine-readable instructions may be part of firmware or software of the computer system 600 or computing device 600. The machine-readable instructions 690 may be stored in the mass storage device 633, in the volatile memory 631, in the non-volatile memory 632, and/or on a removable non-transitory computer-readable storage medium such as a CD or DVD.

In the following, some examples of the proposed concept are presented:

An example (e.g., example 1) relates to a non-transitory computer-readable medium storing instructions that, when executed by one or more processing circuitries, cause the one or more processing circuitries to perform a method for a firmware of a computer system, the method comprising obtaining a first energy consumption value related to an energy consumption of a processor for a first time window, obtaining a second energy consumption value related to the energy consumption of the processor for a second time window, wherein the second time window has a different length than the first time window, wherein the first and second time window overlap, and generating a modified energy consumption value based on the first energy consumption value and the second energy consumption value.

Another example (e.g., example 2) relates to a previous example (e.g., example 1) or to any other example, further comprising that the method comprises calculating an absolute difference between a first power value associated with the first energy consumption value over the first time window and a second power value associated with the second energy consumption value over the second time window, determining an amount of noise based on the calculated absolute difference, and generating the modified energy consumption value by applying the determined amount of noise to an energy consumption value.

Another example (e.g., example 3) relates to a previous example (e.g., example 2) or to any other example, further comprising that the method comprises determining the amount of noise to be hyperbolic, nonlinearly related to the calculated absolute difference.

Another example (e.g., example 4) relates to a previous example (e.g., one of the examples 2 to 3) or to any other example, further comprising that the method comprises adding the noise to the first power value.

Another example (e.g., example 5) relates to a previous example (e.g., one of the examples 2 to 4) or to any other example, further comprising that the method comprises determining the amount of noise to be added to the first energy consumption value.

Another example (e.g., example 6) relates to a previous example (e.g., one of the examples 2 to 5) or to any other example, further comprising that determining the amount of noise comprises providing a base noise factor, and calculating an adaptive noise factor by scaling the base noise factor based on the calculated absolute difference, wherein the adaptive noise factor is hyperbolic, nonlinearly related to the calculated absolute difference.

Another example (e.g., example 7) relates to a previous example (e.g., example 6) or to any other example, further comprising that the adaptive noise factor is calculated by dividing the base noise factor by a term that increases with the calculated absolute difference.

Another example (e.g., example 8) relates to a previous example (e.g., example 7) or to any other example, further comprising that the term is one plus the product of the calculated absolute difference and a configurable scaling factor.

Another example (e.g., example 9) relates to a previous example (e.g., one of the examples 6 to 8) or to any other example, further comprising that the base noise factor is a noise factor for a single-window-based noise injection method.

Another example (e.g., example 10) relates to a previous example (e.g., one of the examples 2 to 9) or to any other example, further comprising that in response to the calculated absolute difference being below a first threshold, the amount of noise is determined to be above a second threshold.

Another example (e.g., example 11) relates to a previous example (e.g., example 10) or to any other example, further comprising that the first threshold is substantially zero, and the amount of noise is determined to be a maximum amount of noise.

Another example (e.g., example 12) relates to a previous example (e.g., example 11) or to any other example, further comprising that the maximum amount of noise corresponds to an amount of noise generated by a single-window-based noise injection method.

Another example (e.g., example 13) relates to a previous example (e.g., one of the examples 1 to 12) or to any other example, further comprising that the first time window is shorter than the second time window.

Another example (e.g., example 14) relates to a previous example (e.g., one of the examples 1 to 13) or to any other example, further comprising that the first energy consumption value is based on a first difference between an energy measurement at a beginning of the first time window and an energy measurement at an end of the first time window and the second energy consumption value is based on a second difference between an energy measurement at a beginning of the second time window and an energy measurement at an end of the second time window.

Another example (e.g., example 15) relates to a previous example (e.g., example 14) or to any other example, further comprising that a first power value is based on the first difference divided by a first value representing the length of the first time window and a second power value is based on the second difference divided by a second value representing the length of the second time window, with the modified energy consumption value being based on addition of an amount of noise which depends on the first power value and the second power value.

Another example (e.g., example 16) relates to a previous example (e.g., one of the examples 1 to 15) or to any other example, further comprising that the modified energy consumption value is configured to mitigate a power side-channel attack.

An example (e.g., example 17) relates to a method for a firmware of a computer system, the method comprising obtaining (310) a first energy consumption value related to an energy consumption of a processor for a first time window, obtaining (320) a second energy consumption value related to the energy consumption of the processor for a second time window, wherein the second time window has a different length than the first time window, wherein the first and second time window overlap, and generating (360) a modified energy consumption value based on the first energy consumption value and the second energy consumption value.

Another example (e.g., example 18) relates to a previous example (e.g., example 17) or to any other example, further comprising that the method comprises calculating (330) an absolute difference between a first power value associated with the first energy consumption value over the first time window and a second power value associated with the second energy consumption value over the second time window, determining (340) an amount of noise based on the calculated absolute difference, and generating (360) the modified energy consumption value by applying the determined amount of noise to an energy consumption value.

Another example (e.g., example 19) relates to a previous example (e.g., example 18) or to any other example, further comprising that the method comprises determining (340) the amount of noise to be hyperbolic, nonlinearly related to the calculated absolute difference.

Another example (e.g., example 20) relates to a previous example (e.g., one of the examples 18 to 19) or to any other example, further comprising that the method comprises adding (350) the noise to the first power value.

Another example (e.g., example 21) relates to a previous example (e.g., one of the examples 18 to 20) or to any other example, further comprising that the method comprises determining (340) the amount of noise to be added to the first energy consumption value.

Another example (e.g., example 22) relates to a previous example (e.g., one of the examples 18 to 21) or to any other example, further comprising that determining (340) the amount of noise comprises providing a base noise factor, and calculating an adaptive noise factor by scaling the base noise factor based on the calculated absolute difference, wherein the adaptive noise factor is hyperbolic, nonlinearly related to the calculated absolute difference.

Another example (e.g., example 23) relates to a previous example (e.g., example 22) or to any other example, further comprising that the adaptive noise factor is calculated by dividing the base noise factor by a term that increases with the calculated absolute difference.

Another example (e.g., example 24) relates to a previous example (e.g., example 23) or to any other example, further comprising that the term is one plus the product of the calculated absolute difference and a configurable scaling factor.

Another example (e.g., example 25) relates to a previous example (e.g., one of the examples 22 to 24) or to any other example, further comprising that the base noise factor is a noise factor for a single-window-based noise injection method.

Another example (e.g., example 26) relates to a previous example (e.g., one of the examples 18 to 25) or to any other example, further comprising that in response to the calculated absolute difference being below a first threshold, the amount of noise is determined to be above a second threshold.

Another example (e.g., example 27) relates to a previous example (e.g., example 26) or to any other example, further comprising that the first threshold is substantially zero, and the amount of noise is determined to be a maximum amount of noise.

Another example (e.g., example 28) relates to a previous example (e.g., example 27) or to any other example, further comprising that the maximum amount of noise corresponds to an amount of noise generated by a single-window-based noise injection method.

Another example (e.g., example 29) relates to a previous example (e.g., one of the examples 17 to 28) or to any other example, further comprising that the first time window is shorter than the second time window.

Another example (e.g., example 30) relates to a previous example (e.g., one of the examples 17 to 29) or to any other example, further comprising that the first energy consumption value is based on a first difference between an energy measurement at a beginning of the first time window and an energy measurement at an end of the first time window and the second energy consumption value is based on a second difference between an energy measurement at a beginning of the second time window and an energy measurement at an end of the second time window.

Another example (e.g., example 31) relates to a previous example (e.g., example 30) or to any other example, further comprising that a first power value is based on the first difference divided by a first value representing the length of the first time window and a second power value is based on the second difference divided by a second value representing the length of the second time window, with the modified energy consumption value being based on addition of an amount of noise which depends on the first power value and the second power value.

Another example (e.g., example 32) relates to a previous example (e.g., one of the examples 17 to 31) or to any other example, further comprising that the modified energy consumption value is configured to mitigate a power side-channel attack.

Another example (e.g., example 33) relates to a computer system comprising a firmware and a processor, wherein the firmware is configured to perform the method according to one of the examples 17 to 32.

Another example (e.g., example 34) relates to a computer system comprising a firmware and a processor, wherein the processor is configured to execute, for the firmware, the instructions stored in the non-transitory computer-readable medium according to one of the examples 1 to 16.

An example (e.g., example 35) relates to an apparatus for a firmware of a computer system, the apparatus comprising one or more interfaces, machine-readable instructions, and processor circuitry to execute the machine-readable instructions to obtain a first energy consumption value related to an energy consumption of a processor for a first time window, obtain a second energy consumption value related to the energy consumption of the processor for a second time window, wherein the second time window has a different length than the first time window, wherein the first and second time window overlap, and generate a modified energy consumption value based on the first energy consumption value and the second energy consumption value.

Another example (e.g., example 36) relates to a previous example (e.g., example 35) or to any other example, further comprising that the processor circuitry is to execute the machine-readable instructions to calculate an absolute difference between a first power value associated with the first energy consumption value over the first time window and a second power value associated with the second energy consumption value over the second time window, determine an amount of noise based on the calculated absolute difference, and generate the modified energy consumption value by applying the determined amount of noise to an energy consumption value.

Another example (e.g., example 37) relates to a previous example (e.g., example 36) or to any other example, further comprising that the processor circuitry is to execute the machine-readable instructions to determine the amount of noise to be hyperbolic, nonlinearly related to the calculated absolute difference.

Another example (e.g., example 38) relates to a previous example (e.g., one of the examples 36 to 37) or to any other example, further comprising that the processor circuitry is to execute the machine-readable instructions to add the noise to the first power value.

Another example (e.g., example 39) relates to a previous example (e.g., one of the examples 36 to 38) or to any other example, further comprising that the processor circuitry is to execute the machine-readable instructions to determine the amount of noise to be added to the first energy consumption value.

Another example (e.g., example 40) relates to a previous example (e.g., one of the examples 36 to 39) or to any other example, further comprising that determining the amount of noise comprises providing a base noise factor, and calculating an adaptive noise factor by scaling the base noise factor based on the calculated absolute difference, wherein the adaptive noise factor is hyperbolic, nonlinearly related to the calculated absolute difference.

Another example (e.g., example 41) relates to a previous example (e.g., example 40) or to any other example, further comprising that the adaptive noise factor is calculated by dividing the base noise factor by a term that increases with the calculated absolute difference.

Another example (e.g., example 42) relates to a previous example (e.g., example 41) or to any other example, further comprising that the term is one plus the product of the calculated absolute difference and a configurable scaling factor.

Another example (e.g., example 43) relates to a previous example (e.g., one of the examples 40 to 42) or to any other example, further comprising that the base noise factor is a noise factor for a single-window-based noise injection method.

Another example (e.g., example 44) relates to a previous example (e.g., one of the examples 36 to 43) or to any other example, further comprising that in response to the calculated absolute difference being below a first threshold, the amount of noise is determined to be above a second threshold.

Another example (e.g., example 45) relates to a previous example (e.g., example 44) or to any other example, further comprising that the first threshold is substantially zero, and the amount of noise is determined to be a maximum amount of noise.

Another example (e.g., example 46) relates to a previous example (e.g., example 45) or to any other example, further comprising that the maximum amount of noise corresponds to an amount of noise generated by a single-window-based noise injection method.

Another example (e.g., example 47) relates to a previous example (e.g., one of the examples 35 to 46) or to any other example, further comprising that the first time window is shorter than the second time window.

Another example (e.g., example 48) relates to a previous example (e.g., one of the examples 35 to 47) or to any other example, further comprising that the first energy consumption value is based on a first difference between an energy measurement at a beginning of the first time window and an energy measurement at an end of the first time window and the second energy consumption value is based on a second difference between an energy measurement at a beginning of the second time window and an energy measurement at an end of the second time window.

Another example (e.g., example 49) relates to a previous example (e.g., example 48) or to any other example, further comprising that a first power value is based on the first difference divided by a first value representing the length of the first time window and a second power value is based on the second difference divided by a second value representing the length of the second time window, with the modified energy consumption value being based on addition of an amount of noise which depends on the first power value and the second power value.

Another example (e.g., example 50) relates to a previous example (e.g., one of the examples 35 to 49) or to any other example, further comprising that the modified energy consumption value is configured to mitigate a power side-channel attack.

An example (e.g., example 51) relates to an apparatus for a firmware of a computer system, the apparatus comprising one or more interfaces and processor circuitry configured to obtain a first energy consumption value related to an energy consumption of a processor for a first time window, obtain a second energy consumption value related to the energy consumption of the processor for a second time window, wherein the second time window has a different length than the first time window, wherein the first and second time window overlap, and generate a modified energy consumption value based on the first energy consumption value and the second energy consumption value.

Another example (e.g., example 52) relates to a previous example (e.g., example 51) or to any other example, further comprising that the processor circuitry is configured to calculate an absolute difference between a first power value associated with the first energy consumption value over the first time window and a second power value associated with the second energy consumption value over the second time window, determine an amount of noise based on the calculated absolute difference, and generate the modified energy consumption value by applying the determined amount of noise to an energy consumption value.

Another example (e.g., example 53) relates to a previous example (e.g., example 52) or to any other example, further comprising that the processor circuitry is configured to determine the amount of noise to be hyperbolic, nonlinearly related to the calculated absolute difference.

Another example (e.g., example 54) relates to a previous example (e.g., one of the examples 52 to 53) or to any other example, further comprising that the processor circuitry is configured to add the noise to the first power value.

Another example (e.g., example 55) relates to a previous example (e.g., one of the examples 52 to 54) or to any other example, further comprising that the processor circuitry is configured to determine the amount of noise to be added to the first energy consumption value.

Another example (e.g., example 56) relates to a previous example (e.g., one of the examples 52 to 55) or to any other example, further comprising that determining the amount of noise comprises providing a base noise factor, and calculating an adaptive noise factor by scaling the base noise factor based on the calculated absolute difference, wherein the adaptive noise factor is hyperbolic, nonlinearly related to the calculated absolute difference.

Another example (e.g., example 57) relates to a previous example (e.g., example 56) or to any other example, further comprising that the adaptive noise factor is calculated by dividing the base noise factor by a term that increases with the calculated absolute difference.

Another example (e.g., example 58) relates to a previous example (e.g., example 57) or to any other example, further comprising that the term is one plus the product of the calculated absolute difference and a configurable scaling factor.

Another example (e.g., example 59) relates to a previous example (e.g., one of the examples 56 to 58) or to any other example, further comprising that the base noise factor is a noise factor for a single-window-based noise injection method.

Another example (e.g., example 60) relates to a previous example (e.g., one of the examples 52 to 59) or to any other example, further comprising that in response to the calculated absolute difference being below a first threshold, the amount of noise is determined to be above a second threshold.

Another example (e.g., example 61) relates to a previous example (e.g., example 60) or to any other example, further comprising that the first threshold is substantially zero, and the amount of noise is determined to be a maximum amount of noise.

Another example (e.g., example 62) relates to a previous example (e.g., example 61) or to any other example, further comprising that the maximum amount of noise corresponds to an amount of noise generated by a single-window-based noise injection method.

Another example (e.g., example 63) relates to a previous example (e.g., one of the examples 51 to 62) or to any other example, further comprising that the first time window is shorter than the second time window.

Another example (e.g., example 64) relates to a previous example (e.g., one of the examples 51 to 63) or to any other example, further comprising that the first energy consumption value is based on a first difference between an energy measurement at a beginning of the first time window and an energy measurement at an end of the first time window and the second energy consumption value is based on a second difference between an energy measurement at a beginning of the second time window and an energy measurement at an end of the second time window.

Another example (e.g., example 65) relates to a previous example (e.g., example 64) or to any other example, further comprising that a first power value is based on the first difference divided by a first value representing the length of the first time window and a second power value is based on the second difference divided by a second value representing the length of the second time window, with the modified energy consumption value being based on addition of an amount of noise which depends on the first power value and the second power value.

Another example (e.g., example 66) relates to a previous example (e.g., one of the examples 51 to 65) or to any other example, further comprising that the modified energy consumption value is configured to mitigate a power side-channel attack.

An example (e.g., example 67) relates to a device for a firmware of a computer system, the device comprising means for processing configured to obtain a first energy consumption value related to an energy consumption of a processor for a first time window, obtain a second energy consumption value related to the energy consumption of the processor for a second time window, wherein the second time window has a different length than the first time window, wherein the first and second time window overlap, and generate a modified energy consumption value based on the first energy consumption value and the second energy consumption value.

Another example (e.g., example 68) relates to a previous example (e.g., example 67) or to any other example, further comprising that the means for processing is configured to calculate an absolute difference between a first power value associated with the first energy consumption value over the first time window and a second power value associated with the second energy consumption value over the second time window, determine an amount of noise based on the calculated absolute difference, and generate the modified energy consumption value by applying the determined amount of noise to an energy consumption value.

Another example (e.g., example 69) relates to a previous example (e.g., example 68) or to any other example, further comprising that the means for processing is configured to determine the amount of noise to be hyperbolic, nonlinearly related to the calculated absolute difference.

Another example (e.g., example 70) relates to a previous example (e.g., one of the examples 68 to 69) or to any other example, further comprising that the means for processing is configured to add the noise to the first power value.

Another example (e.g., example 71) relates to a previous example (e.g., one of the examples 68 to 70) or to any other example, further comprising that the means for processing is configured to determine the amount of noise to be added to the first energy consumption value.

Another example (e.g., example 72) relates to a previous example (e.g., one of the examples 68 to 71) or to any other example, further comprising that determining the amount of noise comprises providing a base noise factor, and calculating an adaptive noise factor by scaling the base noise factor based on the calculated absolute difference, wherein the adaptive noise factor is hyperbolic, nonlinearly related to the calculated absolute difference.

Another example (e.g., example 73) relates to a previous example (e.g., example 72) or to any other example, further comprising that the adaptive noise factor is calculated by dividing the base noise factor by a term that increases with the calculated absolute difference.

Another example (e.g., example 74) relates to a previous example (e.g., example 73) or to any other example, further comprising that the term is one plus the product of the calculated absolute difference and a configurable scaling factor.

Another example (e.g., example 75) relates to a previous example (e.g., one of the examples 72 to 74) or to any other example, further comprising that the base noise factor is a noise factor for a single-window-based noise injection method.

Another example (e.g., example 76) relates to a previous example (e.g., one of the examples 68 to 75) or to any other example, further comprising that in response to the calculated absolute difference being below a first threshold, the amount of noise is determined to be above a second threshold.

Another example (e.g., example 77) relates to a previous example (e.g., example 76) or to any other example, further comprising that the first threshold is substantially zero, and the amount of noise is determined to be a maximum amount of noise.

Another example (e.g., example 78) relates to a previous example (e.g., example 77) or to any other example, further comprising that the maximum amount of noise corresponds to an amount of noise generated by a single-window-based noise injection method.

Another example (e.g., example 79) relates to a previous example (e.g., one of the examples 67 to 78) or to any other example, further comprising that the first time window is shorter than the second time window.

Another example (e.g., example 80) relates to a previous example (e.g., one of the examples 67 to 79) or to any other example, further comprising that the first energy consumption value is based on a first difference between an energy measurement at a beginning of the first time window and an energy measurement at an end of the first time window and the second energy consumption value is based on a second difference between an energy measurement at a beginning of the second time window and an energy measurement at an end of the second time window.

Another example (e.g., example 81) relates to a previous example (e.g., example 80) or to any other example, further comprising that a first power value is based on the first difference divided by a first value representing the length of the first time window and a second power value is based on the second difference divided by a second value representing the length of the second time window, with the modified energy consumption value being based on addition of an amount of noise which depends on the first power value and the second power value.

Another example (e.g., example 82) relates to a previous example (e.g., one of the examples 67 to 81) or to any other example, further comprising that the modified energy consumption value is configured to mitigate a power side-channel attack.

Another example (e.g., example 83) relates to a computer system comprising a firmware with the apparatus or device according to one of the examples 35 to 82 (or according to any other example).

Another example (e.g., example 84) relates to a computer program having a program code for performing the method of one of the examples 17 to 32 (or according to any other example), when the computer program is executed on a computer, a processor, or a programmable hardware component.

The aspects and features described in relation to a particular one of the previous examples may also be combined with one or more of the further examples to replace an identical or similar feature of that further example or to additionally introduce the features into the further example.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components.

Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by one or more processing circuitries, cause the one or more processing circuitries to perform a method for a firmware of a computer system, the method comprising:
obtaining a first energy consumption value related to an energy consumption of a processor for a first time window;
obtaining a second energy consumption value related to the energy consumption of the processor for a second time window, wherein the second time window has a different length than the first time window,
wherein the first and second time window overlap; and
generating a modified energy consumption value based on the first energy consumption value and the second energy consumption value.

2. The non-transitory computer-readable medium according to claim 1, wherein the method comprises calculating an absolute difference between a first power value associated with the first energy consumption value over the first time window and a second power value associated with the second energy consumption value over the second time window, determining an amount of noise based on the calculated absolute difference, and generating the modified energy consumption value by applying the determined amount of noise to an energy consumption value.

3. The non-transitory computer-readable medium according to claim 2, wherein the method comprises determining the amount of noise to be hyperbolic, nonlinearly related to the calculated absolute difference.

4. The non-transitory computer-readable medium according to claim 2, wherein the method comprises adding the noise to the first power value.

5. The non-transitory computer-readable medium according to claim 2, wherein the method comprises determining the amount of noise to be added to the first energy consumption value.

6. The non-transitory computer-readable medium according to claim 2, wherein determining the amount of noise comprises providing a base noise factor, and calculating an adaptive noise factor by scaling the base noise factor based on the calculated absolute difference, wherein the adaptive noise factor is hyperbolic, nonlinearly related to the calculated absolute difference.

7. The non-transitory computer-readable medium according to claim 6, wherein the adaptive noise factor is calculated by dividing the base noise factor by a term that increases with the calculated absolute difference.

8. The non-transitory computer-readable medium according to claim 7, wherein the term is one plus the product of the calculated absolute difference and a configurable scaling factor.

9. The non-transitory computer-readable medium according to claim 6, wherein the base noise factor is a noise factor for a single-window-based noise injection method.

10. The non-transitory computer-readable medium according to claim 2, wherein, in response to the calculated absolute difference being below a first threshold, the amount of noise is determined to be above a second threshold.

11. The non-transitory computer-readable medium according to claim 10, wherein the first threshold is substantially zero, and the amount of noise is determined to be a maximum amount of noise.

12. The non-transitory computer-readable medium according to claim 11, wherein the maximum amount of noise corresponds to an amount of noise generated by a single-window-based noise injection method.

13. The non-transitory computer-readable medium according to claim 1, wherein the first time window is shorter than the second time window.

14. The non-transitory computer-readable medium according to claim 1, wherein the first energy consumption value is based on a first difference between an energy measurement at a beginning of the first time window and an energy measurement at an end of the first time window and the second energy consumption value is based on a second difference between an energy measurement at a beginning of the second time window and an energy measurement at an end of the second time window.

15. The non-transitory computer-readable medium according to according to claim 14, wherein a first power value is based on the first difference divided by a first value representing the length of the first time window and a second power value is based on the second difference divided by a second value representing the length of the second time window, with the modified energy consumption value being based on addition of an amount of noise which depends on the first power value and the second power value.

16. The non-transitory computer-readable medium according to claim 1, wherein the modified energy consumption value is configured to mitigate a power side-channel attack.

17. A method for a firmware of a computer system, the method comprising:
obtaining a first energy consumption value related to an energy consumption of a processor for a first time window;
obtaining a second energy consumption value related to the energy consumption of the processor for a second time window, wherein the second time window has a different length than the first time window,
wherein the first and second time window overlap; and
generating a modified energy consumption value based on the first energy consumption value and the second energy consumption value.

18. The method according to claim 17, wherein the method comprises calculating an absolute difference between a first power value associated with the first energy consumption value over the first time window and a second power value associated with the second energy consumption value over the second time window, determining an amount of noise based on the calculated absolute difference, and generating the modified energy consumption value by applying the determined amount of noise to an energy consumption value.

19. An apparatus for a firmware of a computer system, the apparatus comprising one or more interfaces, machine-readable instructions, and processor circuitry to execute the machine-readable instructions to:
obtain a first energy consumption value related to an energy consumption of a processor for a first time window;
obtain a second energy consumption value related to the energy consumption of the processor for a second time window, wherein the second time window has a different length than the first time window,
wherein the first and second time window overlap; and
generate a modified energy consumption value based on the first energy consumption value and the second energy consumption value.

20. The apparatus according to claim 19, wherein the processor circuitry is to execute the machine-readable instructions to calculate an absolute difference between a first power value associated with the first energy consumption value over the first time window and a second power value associated with the second energy consumption value over the second time window, determine an amount of noise based on the calculated absolute difference, and generate the modified energy consumption value by applying the determined amount of noise to an energy consumption value.
